(19) United States
(12) Patent Application Publication
(10) Pub. No.: US 2008/0036214 A1
(43) Pub. Date: Feb. 14, 2008

(54) Wind energy using a sail and a spring

(76) Inventor: Edwin Newman, Palmdale, CA (US)

Correspondence Address: Edwin Newman, 2854 Nandina Dr., Palmdale, CA, 93550, US

(21) Appl. No.: 11/502,718

(22) Filed: Aug. 14, 2006

(51) Int. Cl. F03D 9/00; H02P 9/04

(52) U.S. Cl. 290/55

(57) ABSTRACT

A wind energy system utilizing a sail. The sail is mounted on top of a lever which is placed vertically. At the bottom of the lever is a spring so as wind strikes the sail at uneven pressure the spring is made to alternately be pressed and released. As the lever is made to swing it operates gearing connected to a generator, producing electricity.

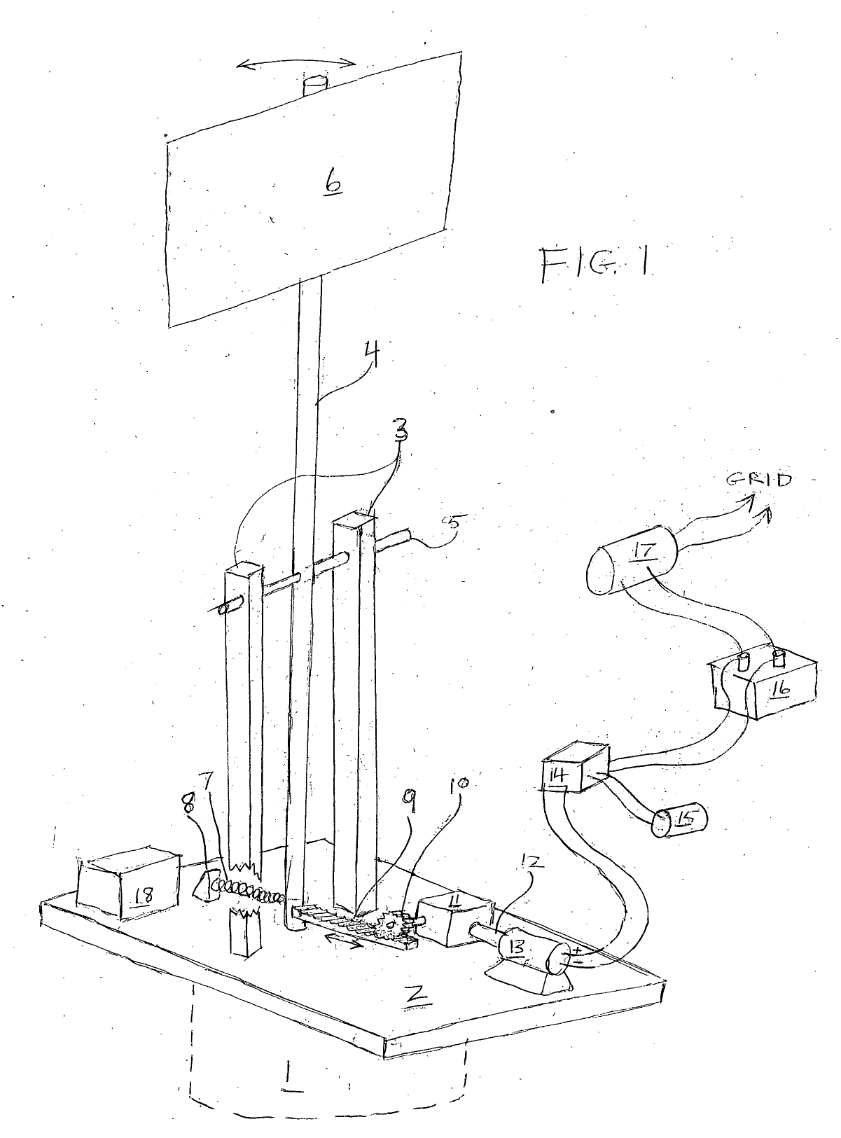

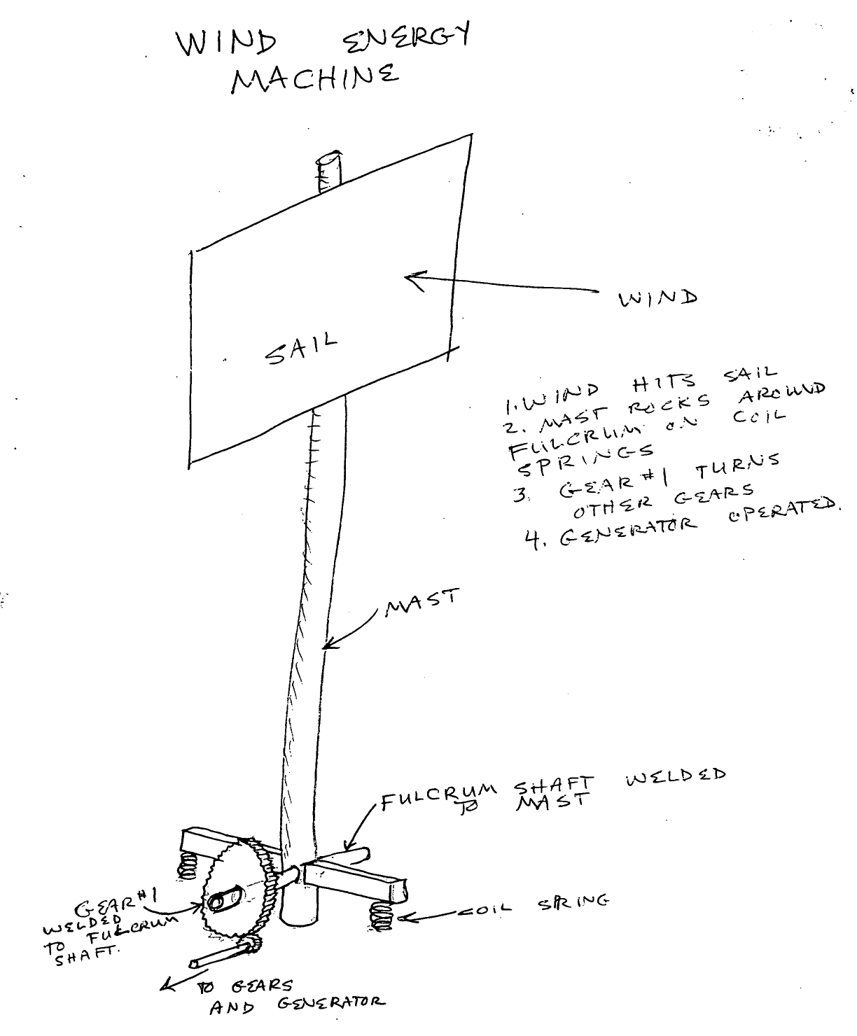

### BACKGROUND OF THE INVENTION

In my U.S. Pat. No. 7,043,904 we see wind energy produced through the agency of a sail mounted on a pole. This pole is made to act, as a lever and operate hydraulic machinery to activate a generator, producing electricity.

### SUMMARY OF THE INVENTION

The invention uses a mechanical spring instead of a hydraulic apparatus. There is a sail mounted on a vertical lever. At the bottom of the lever on a side normal to the fulcrum is mounted a spring parallel to the ground. On the opposite side of the lever and at the level of the spring is mounted a gear rack also parallel to the ground. This gear rack is made to mesh with a pinion gear. As gusts of wind cause the lever to be rotated about the fulcrum the bottom of the lever pulls on the gear rack and compresses the spring. As the wind gust loses velocity the restoring force of the spring pushes on the gear rack. Thus, in a wind, the pinion gear is made to move back and forth. Connected to the pinion gear are other gears and an electric generator so that electricity is produced.

The aim of the invention is to substitute a cheaper and less complicated alternative to the hydraulic devices used in U.S. Pat. No. 7,043,904 when using a sail to extract wind energy from the wind.

### BRIEF DESCRIPTION OF THE DRAWINGS

The FIGURE is a perspective view of the whole invention.

### DETAILED DESCRIPTION OF THE PREFERRED EMBODIMENT

Turning to the FIGURE, we see a revolveable turntable 2 mounted on a cement foundation 1. Fixed to turntable 2 are two poles 3. A round rod 5 serves as a fulcrum for lever 4. Mounted atop lever 4 is sail 6. The bottom end of lever 4 almost touches turn-table 2. Fixture 8 is fixed to turntable 2 and one end of spring 7. The other end of spring 7 is fixed to a side of lever 4 normal to fulcrum 5. Opposite spring 7 at the same level there is affixed to lever 4 a gear rack 9 at 90 degrees to lever 4. Made to mesh with gear rack 9 is pinion gear 10 operably connected to gearbox 11 and electrical generator 13. Shaft 12 connects gearbox 11 and generator 13. The electric wires from generator 13 are routed to charge controller 14 which is operably connected to a resistor 15, called a Dump Load, and battery 16. The electric output of the battery 16 is routed through inverter 17 to the grid. I have found the use of counterweights 18 to be useful.

The sail may be painted with a design.

In operation, the wind strikes sail 6 at one end of lever 4 with uneven pressure over time and causes spring 7 at the other end of lever 7 to compress and expand, causing gear rack 9 to move back and forth, operating the aforementioned machinery 11,12,13 to produce electricity in a way well known in the art. From the above description it is apparent that the preferred embodiment acheives the object of the present invention. Alternative embodiments and various modifications of the preferred embodiment will be apparent to those skilled in the art.

I claim:

1. A wind energy conversion system comprising a vertically disposed lever with a sail means fixedly attached to said lever above a fulcrum of said lever and a spring means fixedly attached to said lever below said fulcrum so as gusts of wind strike said sail said lever is made to rotate back and forth around said fulcrum according to the action of said spring and said lever being operatively connected to an energy conversion means.

2. The system of claim 1 wherein said energy conversion means comprises a gear means operatively connected to said lever and an electric generator operatively connected to said gear means so said wind is made to operate said electric generator.
